(19) United States
(12) Patent Application Publication
(10) Pub. No.: US 2017/0060062 A1
(43) Pub. Date: Mar. 2, 2017

(54) KEY SWITCH DEVICE AND IMAGE FORMING APPARATUS

(71) Applicant: KYOCERA Document Solutions Inc., Osaka (JP)

(72) Inventor: Kuniaki ARAISHI, Osaka (JP)

(21) Appl. No.: 15/236,891

(22) Filed: Aug. 15, 2016

(30) Foreign Application Priority Data
Aug. 27, 2015 (JP) 2015-168272

(51) Int. Cl. G03G 15/00; H01H 3/12; H01H 13/83; H01H 13/85; H01H 13/70; H01H 1/14

(52) U.S. Cl. CPC G03G 15/5016; H01H 13/70; H01H 1/14; H01H 13/83; H01H 13/85; H01H 3/12; H01H 2233/07

(57) ABSTRACT

A key switch device includes a pressing type switch, an operating key, and a light emitting unit. The operating key includes a key top and a key base. The key top is exposed from an operating panel and is pressed by a user. The key base is assembled with the key top. The key base is positioned between a substrate and the operating panel to turn on the switch. In a place corresponding to the light emitting unit between the key top and the key base, a hollow part is formed.

### CROSS-REFERENCE TO RELATED APPLICATION

This application is based upon and claims the benefit of priority from Japanese Patent Application No. 2015-168272 filed on Aug. 27, 2015, the entire contents of which are incorporated herein by reference.

### BACKGROUND

The technology of the present disclosure relates to a key switch device and an image forming apparatus including the same.

In a key switch device in which a light emitting unit such as an LED is provided directly under a key top to make the key top to shine, there is proposed a technology in which light emitted from the light emitting unit is effectively collected in a light guide unit to make the key top to shine.

### SUMMARY

A key switch device according to one aspect of the present disclosure includes a pressing type switch, an operating key, and a light emitting unit. The pressing type switch is arranged in a substrate and covered with an operating panel. The operating key is arranged between the substrate and the operating panel in a state in which a part of the operating key is exposed from the operating panel. The operating key turns on the aforementioned switch by a pressing operation of a user and is composed of light transmitting resin. The light emitting unit is arranged in a place corresponding to the operating key in the substrate and emits light, thereby making the aforementioned operating key to shine.

The operating key includes a key top and a key base. The key top is exposed from the operating panel and pressed by a user. The key base is assembled with the key top. The key base is positioned between the aforementioned substrate and the aforementioned operating panel to turn on the aforementioned switch. In a place corresponding to the aforementioned light emitting unit between the key top and the key base, a hollow part is formed.

### BRIEF DESCRIPTION OF THE DRAWINGS

FIG. 1 is a schematic configuration diagram of an image forming apparatus.

FIG. 2 is a perspective view of an image reading unit and an operating unit.

FIG. 3 is a perspective view taken along line III-III of FIG. 2.

FIG. 4 is an enlarged view of a key switch device of a return key side in FIG. 3.

FIG. 5 is an enlarged perspective view of a key switch device of a return key side.

FIG. 6 is a perspective view of a key top of a return key.

FIG. 7 is a perspective view of a key base of a return key side.

FIG. 8 is a plan view of a key base.

FIG. 9 is a perspective view when a key base is viewed from a front side.

FIG. 10 is perspective view when a key base is viewed from a rear side.

FIG. 11 is a perspective view taken along line XI-XI of FIG. 7.

FIG. 12 is a diagram corresponding to FIG. 4, which illustrates a modification 1.

FIG. 13 is a diagram corresponding to FIG. 11, which illustrates a modification 2.

FIG. 14 is a diagram corresponding to FIG. 4, which illustrates a modification 3.

### DETAILED DESCRIPTION

Hereinafter, embodiments of the technology of the present disclosure will be described in detail on the basis of the drawings. It is noted that the technology of the present disclosure is not limited to the following embodiments.

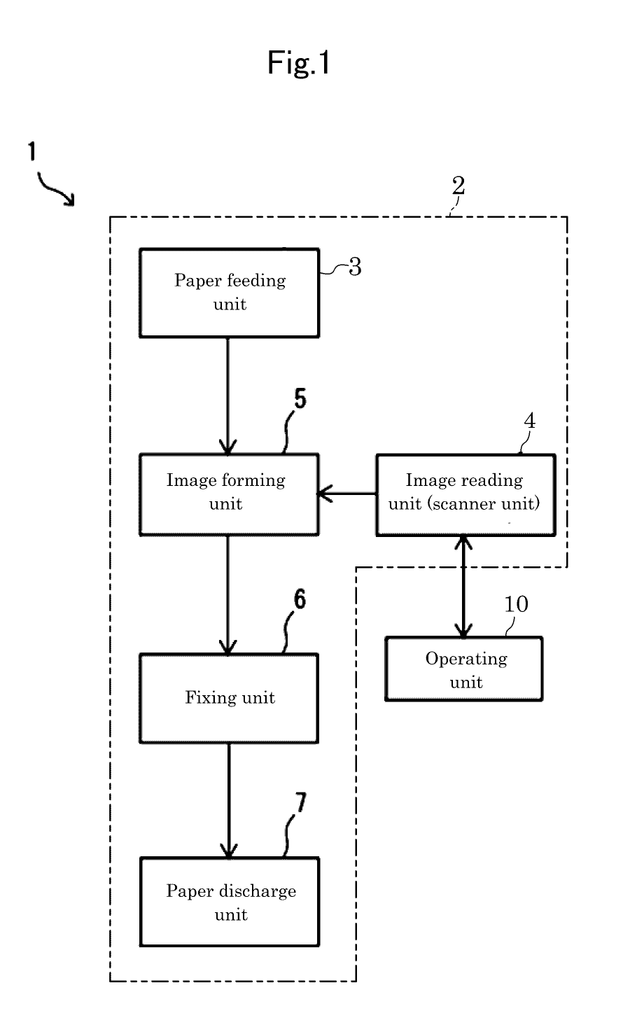

As illustrated in FIG. 1, an image forming apparatus 1 of the present embodiment, for example, is a multifunctional peripheral (MFP) and has an image forming apparatus body 2 and an operating unit 10. The image forming apparatus body 2 includes a paper feeding unit 3, an image reading unit (a scanner unit) 4, an image forming unit 5, a fixing unit 6, and a paper discharge unit 7. The paper feeding unit 3 is a cassette paper feeding unit or a manual feed tray that supplies papers to the image forming unit 5. The image reading unit 4 reads a document as an image. In the operating unit 10, various operations of the image forming apparatus 1 are performed by a user. Although not illustrated in FIG. 1, the image forming unit 5 includes a photosenstive drum, and a charging device, a developing device, a transfer roller and the like which are arranged around the photosensitive drum. In the image forming unit 5, a toner image is transferred to a paper supplied from the paper feeding unit 3 on the basis of image data read by the image reading unit 4 or image data transmitted from an external terminal. The fixing unit 6 includes a fixing roller and a pressure roller (all not illustrated), which rotate in press-contact with each other, and fixes the image (the toner image), which has been transferred to the paper in the image forming unit 5, to the paper. The paper discharge unit 7 receives the paper subjected to the image formation, which is supplied from the fixing unit 6.

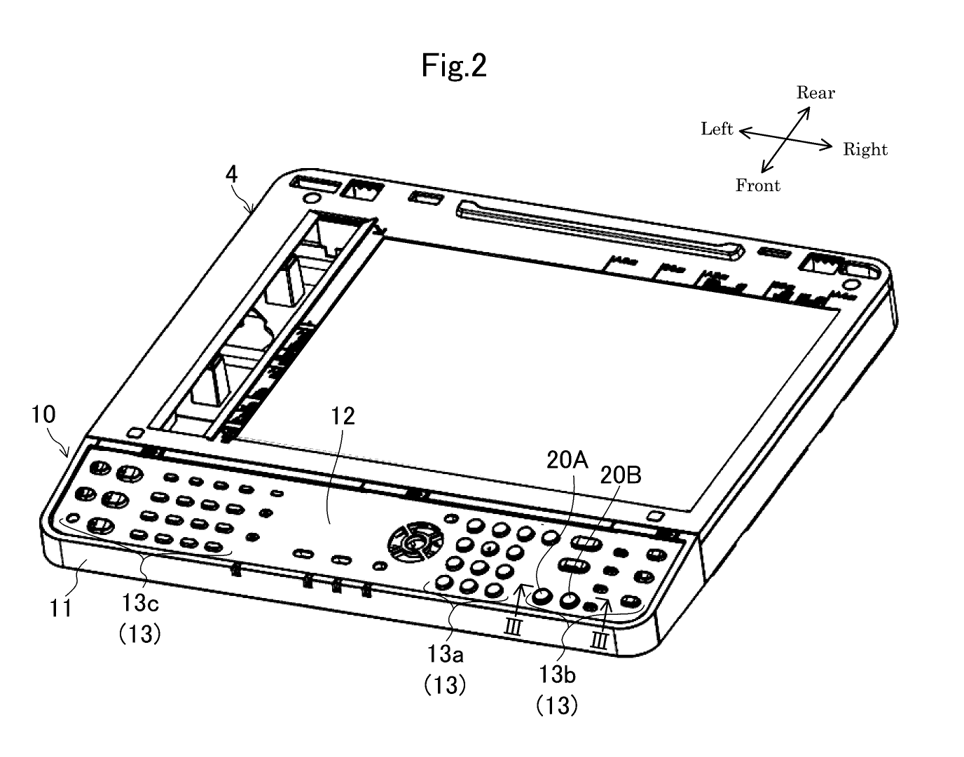

As illustrated in FIG. 2, the operating unit 10 has an operating case 11 opened upward and having a flat hollow shape, an operating panel 12 that closes an upper side of the operating case 11, and a plurality of key switch devices 13 for performing various functions of the image forming apparatus 1. The operating unit 10 receives an operating signal of each key switch device 13 by a user and performs a predetermined image forming operation for the image forming apparatus body 2 in response to the received operating signal. In the following description, a left side and a right side are assumed to indicate a left side and a right side when the image forming apparatus 1 is viewed from a front side (that is, a side at which the operating panel 12 is positioned).

The operating case 11 and the operating panel 12 form a rectangular shape which is long in a right and left direction in a plan view. The plurality of key switch devices 13 are largely classified into a key switch device group 13a having a plurality of operating keys including a numeric keypad for inputting numerical values, a key switch device group 13b having a plurality of operating keys including a start key 20A and a return key 20B, and a key switch device group 13c having a plurality of operating keys including character keys for inputting characters such as alphabets.

The start key 20A is a key for allowing the image forming apparatus 1 to start a job.

The return key 20B is a key for returning the image forming apparatus 1 to a normal mode from an energy saving mode. The normal mode is a mode in which power is supplied to all devices required in a print operation in the image forming apparatus 1. On the other hand, the energy saving mode, for example, is a mode in which power is supplied only to a substrate 15 in the operating panel 12. When a key operation by a user has not been detected for a predetermined time or more in the normal mode, the image forming apparatus 1 automatically switches an operation mode from the normal mode to the energy saving mode. When it is detected that the return key 20B has been operated by a user in the energy saving mode, the image forming apparatus 1 returns to the normal mode from the energy saving mode.

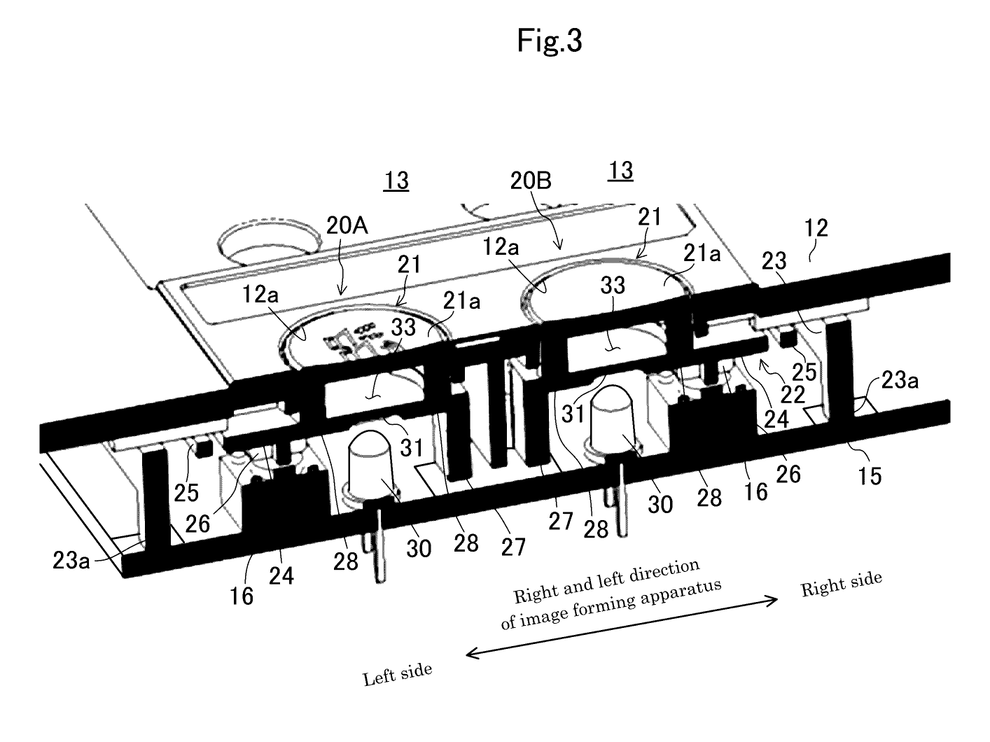

As illustrated in FIG. 3 to FIG. 5, the substrate 15 is received in the operating case 11. The key switch device 13 includes a pressing type switch 16 arranged in the substrate 15 and covered with the operating panel 12.

Hereinafter, the key switch device 13 having the return key 20B as an operating key will be described as an example. Since the start key 20A is also basically configured in a similar manner, a description of the key switch device 13 having the start key 20A will be omitted. It is noted that a similar structure may be applied to a numeric keypad.

The return key 20B, for example, is composed of light transmitting resin such as silicone resin, acrylic resin (PMMA), polystyrene, and polycarbonate, is arranged between the substrate 15 and the operating panel 12 so that a part thereof is exposed to an exterior from an upper surface of the operating panel 12, and turns on the switch 16 by a pressing operation of a user. An ON or OFF signal of the switch 16 is transmitted to a controller (not illustrated) connected to the substrate 15. The controller recognizes a user request for the image forming apparatus 1 based on a signal transmitted from the switch 16 through the substrate 15, and performs predetermined processing corresponding to the recognized request.

At a lateral side of the switch 16 of the substrate 15, a light emitting unit (LED) 30 is arranged. The light emitting unit 30 is arranged in a place corresponding to the return key 20B in the substrate 15. The return key 20B is made to shine by light emitted from the light emitting unit 30. In this way, even in a room after the light is turned off, a user can easily recognize the position of the return key 20B.

The return key 20B is divided into two by an upper key top 21 and a lower key base 22. The key top 21 is exposed from the operating panel 12 such that it can be pressed by a user. The key base 22 is assembled with the key top 21, is positioned between the substrate 15 and the operating panel 12, and turns on the switch 16.

The key top 21 has a cylindrical cup shape opened downward, and its upper surface 21a is exposed to an upper surface of the operating panel 12 from a circular hole 12a of the operating panel 12. On the upper surface 21a of the key top 21, a character such as alphabets, a numerical value and the like (not illustrated) are displayed, so that a user presses the upper surface 21a with his/her fingers.

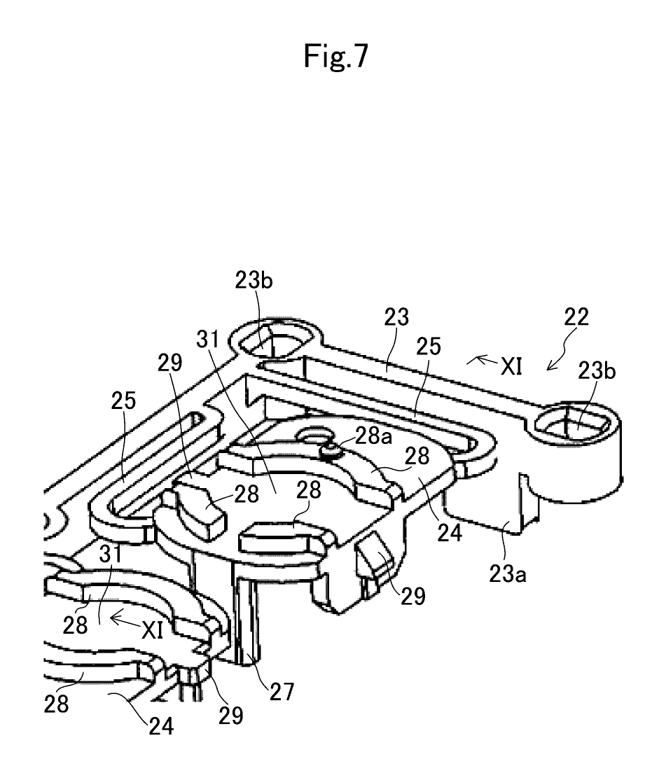

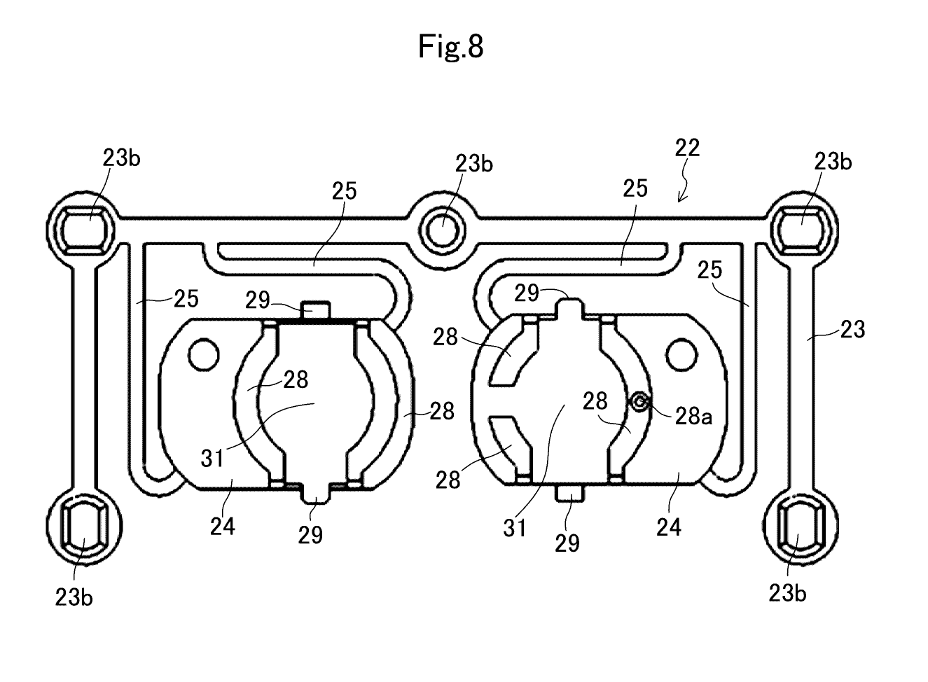

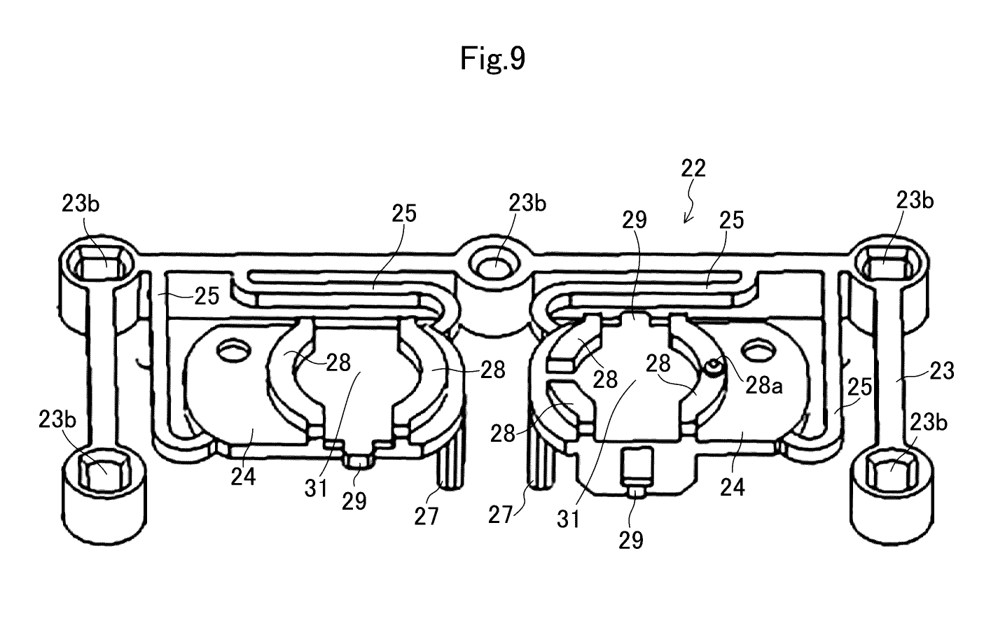

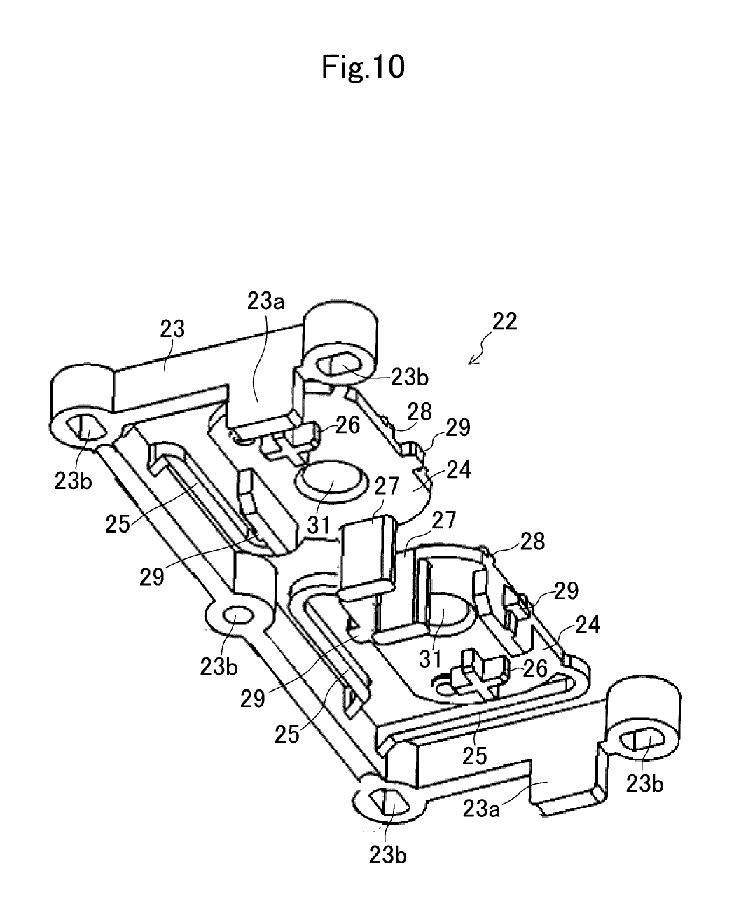

As illustrated in FIG. 7 to FIG. 11, the key base 22 includes a support frame 23 having support legs 23a at both right and left sides thereof one by one. Inside the support frame 23, key base bodies 24 having an approximately rectangular plate shape are arranged to respectively support the key tops 21 of the start key 20A and the return key 20B from below. These key base bodies 24 are respectively supported to the support frame 23 via a pair of arm parts 25 connected at a diagonal position. The support frame 23 is mounted in the substrate 15 via the support legs 23a, and support the key tops 21 of the start key 20A and the return key 20B via the key base bodies 24 and the arm parts 25. Positioning pins (not illustrated) are inserted into five positioning holes 23b formed at an equal interval, so that the support frame 23 is positioned in the operating panel 12.

The key base body 24 is larger than the circular hole 12a of the operating panel 12 and prevents the key top 21 from protruding upward from the circular hole 12a.

At one end side of a rear surface of the key base body 24, a cross-shaped abutting part 26 is projected to abut the switch 16. At the other end side of the rear surface of the key base body 24, a restraint leg 27 is projected to abut the substrate 15 when the key top 21 has been pressed and restraints a downward movement amount of the key top 21.

On the surface of the right key base body 24, projection bar parts 28 for placing the key top 21 thereon are projected in correspondence to an open end surface of the key top 21 (see FIG. 7 to FIG. 9 and FIG. 11), wherein one is positioned at the right side of the right key base body 24 and two are positioned at the left side thereof. On the surface of the left key base body 24, projection bar parts 28 for placing the key top 21 thereon are projected in correspondence to the open end surface of the key top 21 (see FIG. 7 to FIG. 9), wherein one is positioned at the right side of the right key base body 24 and one is positioned at the left side thereof. Front and rear side of the key base body 24, two engaging claws 29 are projected so as to be positioned between the right and left projection bar parts 28. In an area (a place corresponding to the light emitting unit 30) surrounded by the three projection bar parts 28 of the key base body 24, a flat thin part 31 with a thin thickness as compared with other areas around the area is formed. At the right projection bar part 28 in the right key base body 24, a positioning protrusion 28a is formed to allow the key top 21 to be positioned on the projection bar part 28.

On the open end surface of the key top 21 mounted in the right key base body 24, a positioning concave part (not illustrated), with which the positioning protrusion 28a of the projection bar part 28 engages, is formed; whereas on the open end surface of the key top 21 mounted in the left key base body 24, no positioning concave part is formed. This is for preventing a mistake at the time of assembly work because the right and left key tops 21 have the same external appearance shape and their respective upper surfaces 21a have been printed with marks indicating respective key functions. That is, since no positioning concave part has been formed in the key top 21 to be mounted at the left side, it is not possible to mount the key top 21 in the right key base body 24 in interference with the positioning protrusion 28a. Consequently, an arrangement of the right and left key tops 21 can be prevented from being reversed.

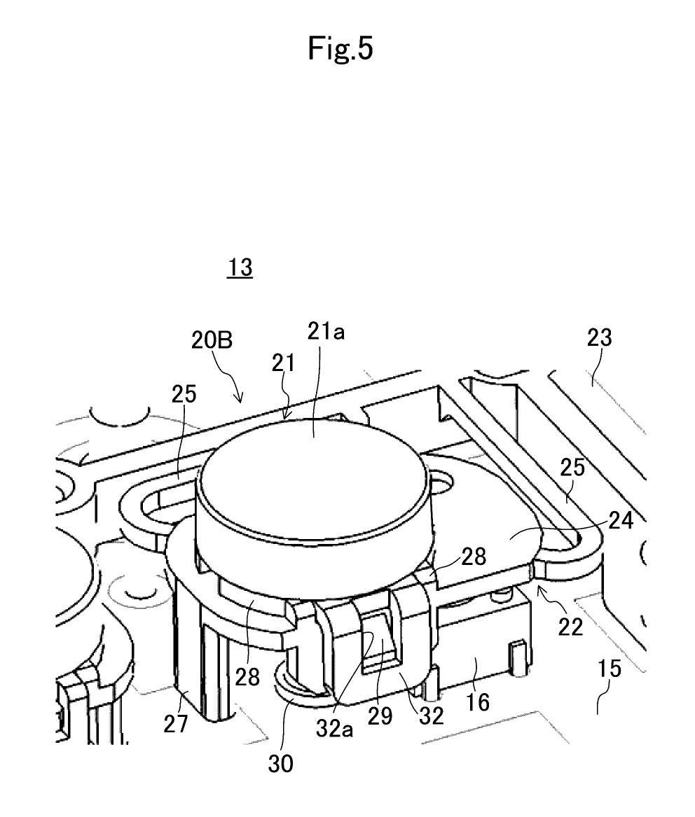

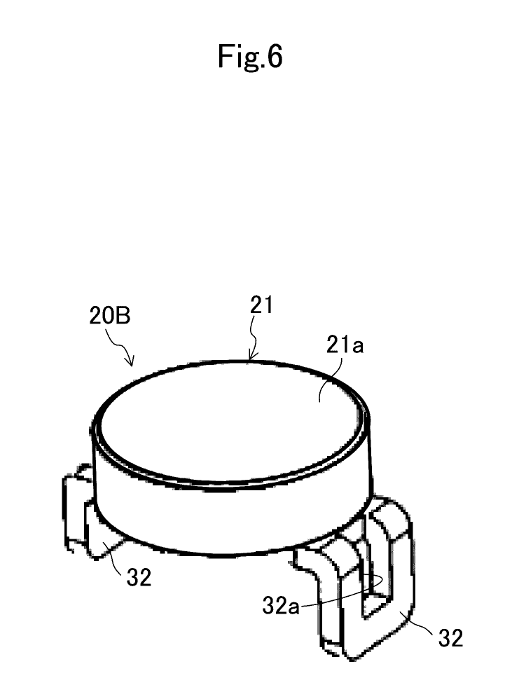

As illustrated in FIG. 5 and FIG. 6, on the open end surface of the key top 21, engaging pieces 32 each having an engaging hole 32a are projected so as to be positioned at an opposite side by 180°. The engaging claw 29 is allowed to be engaged with the engaging hole 32a, so that the key top 21 is assembled to the key base 22.

In a place corresponding to the light emitting unit 30 between the key top 21 and the key base body 24, the open end surface of the key top 21 and the projection bar part 28 of the key base body 24 abuts each other, so that a hollow part 33 is formed.

When the key top 21 is viewed from directly above, the light emitting unit 30 is positioned directly under the flat thin part 31 of the key base body 24 and light emitted from the light emitting unit 30 passes through the flat thin part 31 and the hollow part 33 and reaches the upper surface 21a of the key top 21.

Then, when the key top 21 of the return key 20B is pressed down by a user, the arm parts 25 are bent downward and the key top 21 is sunk down to a lower side. Accordingly, the abutting part 26 of the key base 22 is sunk down to the lower side, so that the switch 16 is pressed by the abutting part 26. In this way, the switch 16 is switched from OFF to ON. At this time, a user can feel reaction force from the switch 16 by his/her fingers, thereby getting click feeling.

Meanwhile, with the miniaturization of an apparatus, a distance from the substrate 15, on which the light emitting unit 30 and the switch 16 are arranged, to the operating panel 12, which covers the light emitting unit 30 and the switch 16, becomes short, but there is a case in which the size of the light emitting unit 30 or the switch 16 is not changed as with the conventional art. In this case, since it is not possible to sufficiently ensure a design space of the light emitting unit and it is difficult to diffuse light, when the light emitting unit 30 arranged directly under the key top 21 has been turned on, the bright spot of the light emitting unit 30 may be distinctly seen and conspicuous at the center part of the key top 21.

However, in the present embodiment, since the return key 20B is configured with the key top 21 and the key base body 24 and the hollow part 33 is formed in a place corresponding to the light emitting unit 30 therebetween, light emitted from the light emitting unit 30 passes through the key base body 24, passes through the key top 21 via the hollow part 33, and then passes through the wall of the resin twice, so that a diffusion effect is improved. Consequently, even when the distance from the substrate 15 to the operating panel 12 becomes short with the miniaturization of an apparatus and it is not possible to sufficiently ensure the design space of the light emitting unit, the bright spot is blurry and the key top 12 can be uniformly turned on.

Furthermore, when the return key 20B is configured with one part without being divided into two parts by the key top and the key base 22, it is necessary to increase the thickness of the return key 20B in order to diffuse light emitted from the light emitting unit 30, but there is a problem that sinks and voids occur at the time of molding. However, in the present embodiment, the return key 20B is divided into two parts of the key top 21 and the key base 22 (the key base body 24), and the respective parts are made thin. Moreover, in a place of the key base body 24, which corresponds to the light emitting unit 30, the flat thin part 31 with a thin thickness, as compared with other areas around the place, is formed, so that no sinks and voids occur at the time of molding.

(Modification 1)

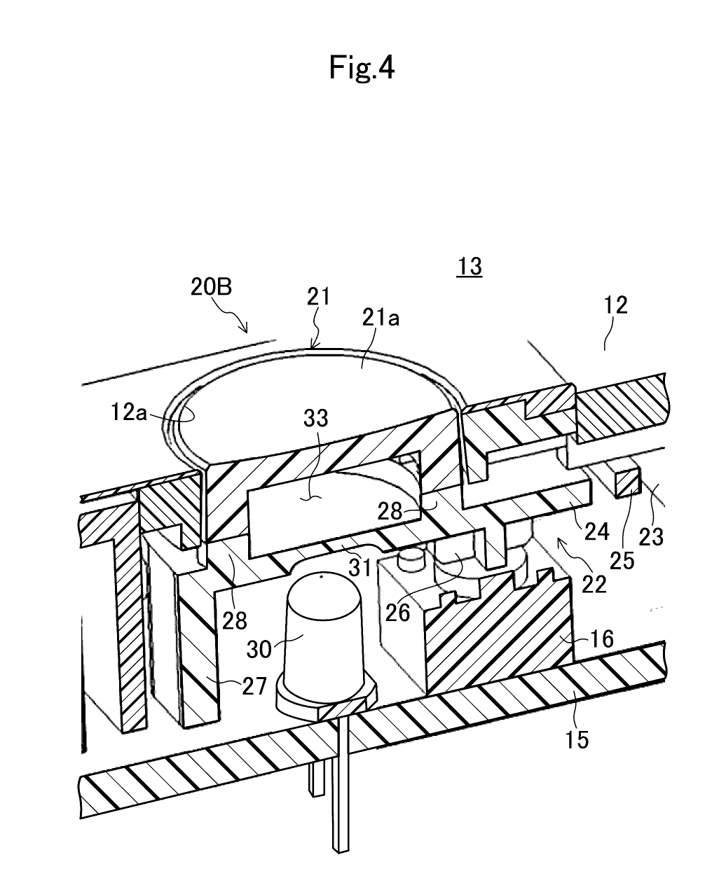

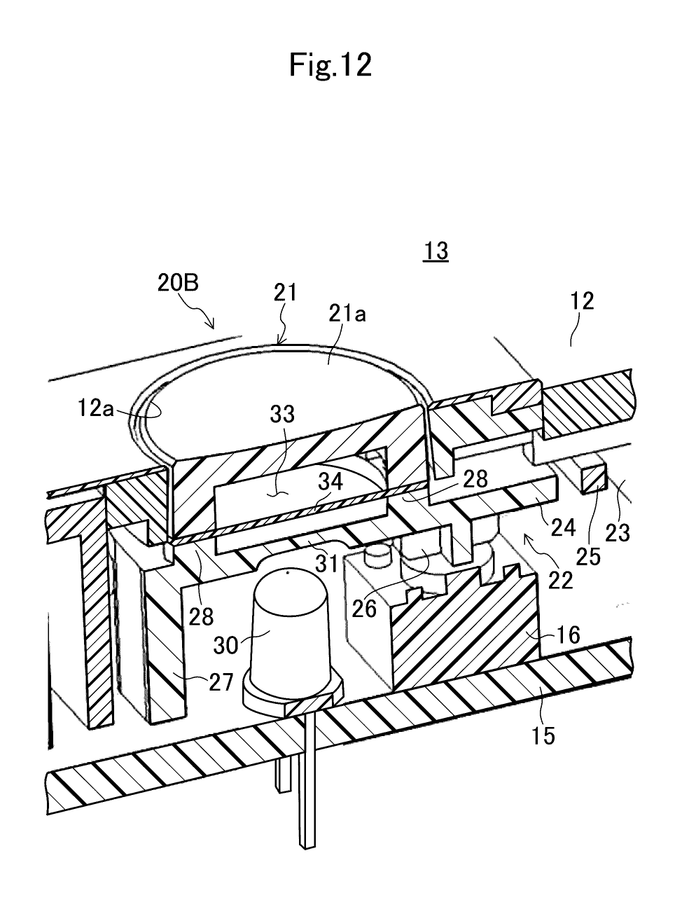

FIG. 12 is a diagram corresponding to FIG. 4, which illustrates the modification 1. In the modification 1, in the place corresponding to the light emitting unit 30 between the key top 21 and the key base 22 (the key base body 24), an intermediate sheet 34 composed of light transmitting resin and diffusing light is interposed therebetween such that the hollow part 33 is divided into two. According to this, since light emitted from the light emitting unit 30 passes through the wall of the resin three times in sequence to the key base body 24, the intermediate sheet 34, and the key top 21, a diffusion effect is further improved, so that it is possible to efficiently shade off a bright spot.

(Modification 2)

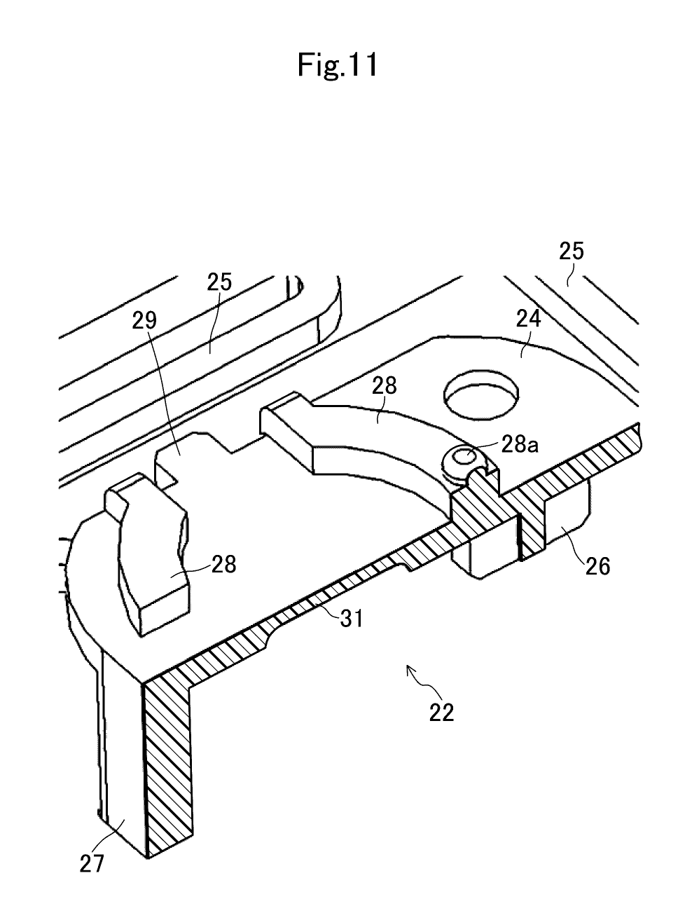

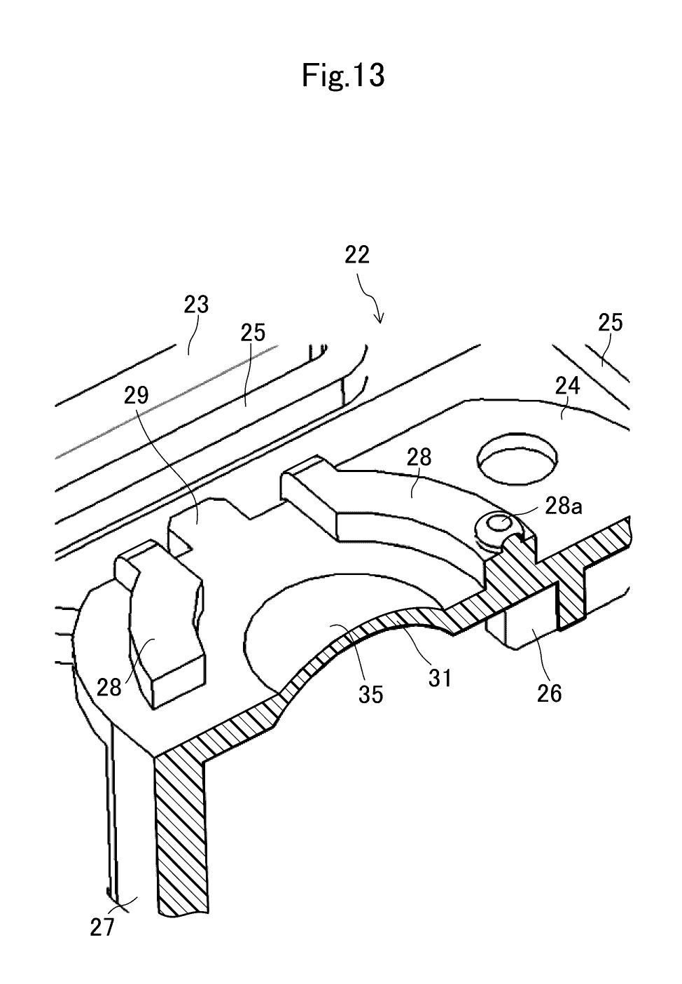

FIG. 13 is a diagram corresponding to FIG. 11, which illustrates the modification 2. In the modification 2, in the place of the key base 22 (the key base body 24), which corresponds to the light emitting unit 30, a spherical thin part 35 is formed. According to this, light emitted from the light emitting unit 30 is efficiently diffused in the spherical thin part 35.

(Modification 3)

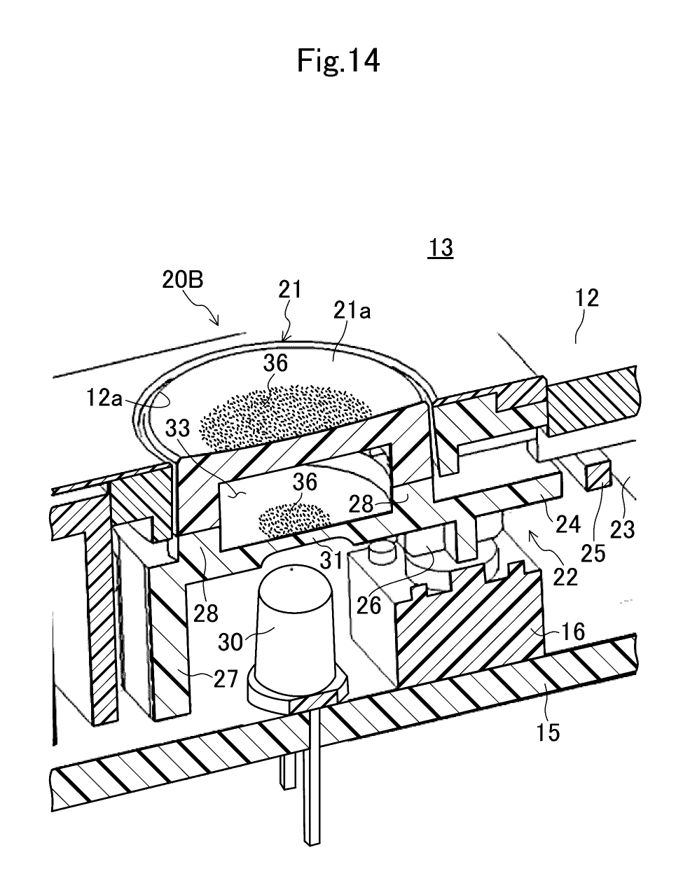

FIG. 14 is a diagram corresponding to FIG. 4, which illustrates the modification 3. In the modification 3, in the place of the key base 22 (the key base body 24), which corresponds to the light emitting unit 30, an embossed surface 36 is formed. According to this, light emitted from the light emitting unit 30 is efficiently diffused with fine irregularity of the embossed surface 36.

(Modification 4)

In the modification 4, although not illustrated, the light diffusion coefficient of the place of the key base 22 (the key base body 24), which corresponds to the light emitting unit 30 is higher than that of the key top 21. In order to change the light diffusion coefficient, a mixed amount of a light diffusion material with respect to resin is changed. As the light diffusion material, for example, it is possible to use titanium oxide, glass beads, calcium carbonate, aluminum powder, mica and the like. The light diffusion material may be contained in both the key top 21 and the key base 22 (the key base body 24), or may be contained only in the key base 22 (the key base body 24). According to this, light emitted from the light emitting unit 30 is efficiently diffused with the light diffusion material.

What is claimed is:

1. A key switch device comprising:
a pressing type switch which is arranged in a substrate and covered with an operating panel;
an operating key which is arranged between the substrate and the operating panel in a state in which a part of the operating key is exposed from the operating panel, turns on the switch by a pressing operation of a user, and is composed of light transmitting resin; and
a light emitting unit which is arranged in a place corresponding to the operating key in the substrate and emits light, thereby making the operating key to shine,
wherein the operating key comprises:
a key top which is exposed from the operating panel and pressed by a user; and
a key base which is assembled with the key top and is positioned between the substrate and the operating panel to turn on the switch,
wherein a hollow part is formed in a place corresponding to the light emitting unit between the key top and the key base.

2. The key switch device of claim 1, wherein, in the place corresponding to the light emitting unit between the key top and the key base, an intermediate sheet including light transmitting resin is interposed between the key top and the key base such that the hollow part is divided into two.

3. The key switch device of claim 1, wherein, in the place of the key base, which corresponds to the light emitting unit, a spherical part is formed.

4. The key switch device of claim 1, wherein a light diffusion coefficient of the place of the key base, which corresponds to the light emitting unit, is higher than a light diffusion coefficient of the key top.

5. The key switch device of claim 1, wherein, in the place of the key base, which corresponds to the light emitting unit, an embossed surface is formed.

6. An image forming apparatus including the key switch device of claim 1.
